(19) United States
(12) Patent Application Publication
(10) Pub. No.: US 2024/0254348 A1
(43) Pub. Date: Aug. 1, 2024

(54) PRINTING INK

(71) Applicant: Fujifilm Speciality Ink Systems Limited, Broadstairs Kent (GB)

(72) Inventors: Brian Woolrich, Broadstairs Kent (GB); Alasdair Meadows, Broadstairs Kent (GB); Seán Slater, Broadstairs Kent (GB); Katie Ralph, Broadstairs Kent (GB)

(21) Appl. No.: 18/289,527

(22) PCT Filed: May 6, 2022
(86) PCT No.: PCT/GB2022/051155

§ 371 Date: Nov. 3, 2023

(30) Foreign Application Priority Data
May 7, 2021 (GB) 2106538.8

(51) Int. Cl. C09D 11/322

(52) U.S. Cl. CPC C09D 11/322

(57) ABSTRACT

The present invention provides a white inkjet ink comprising: tricyclodecane dimethanol diacrylate; at least one of a difunctional urethane (meth)acrylate oligomer, (2-methyl-2-ethyl-1,3-dioxolane-4-yl)methyl acrylate and a polyethylene glycol diacrylate; a white pigment; and a monofunctional monomer, other than (2-methyl-2-ethyl-1,3-dioxolane-4-yl)methyl acrylate. The present invention further provides a method of inkjet printing comprising inkjet printing the inkjet ink of the present invention onto a substrate and curing the inkjet ink by exposing the inkjet ink to a curing source, preferably wherein the curing source is a UV LED light.

The present invention relates to a printing ink and in particular, to a white inkjet ink which can achieve a desirable balance of properties, even when the cure source is a UV LED source.

In inkjet printing, minute droplets of black, white or coloured ink are ejected in a controlled manner from one or more reservoirs or printing heads through narrow nozzles on to a substrate, which is moving relative to the reservoirs. The ejected ink forms an image on the substrate.

For high-speed printing, the inks must flow rapidly from the printing heads, and, to ensure that this happens, they must have in use a low viscosity, typically 200 mPas or less at 25° C., although in most applications the viscosity should be 50 mPas or less, and often 25 mPas or less. Typically, when ejected through the nozzles, the ink has a viscosity of less than 25 mPas, preferably 5-15 mPas and most preferably between 7-11 mPas at the jetting temperature, which is often elevated to, but not limited to 40-50° C. (the ink might have a much higher viscosity at ambient temperature). The inks must also be resistant to drying or crusting in the reservoirs or nozzles. For these reasons, inkjet inks for application at or near ambient temperatures are commonly formulated to contain a large proportion of a mobile liquid vehicle or solvent such as water or a low-boiling solvent or mixture of solvents.

Another type of inkjet ink contains radiation-curable material, such as radiation-curable monomers and/or oligomers, which polymerise when cured. By “radiation-curable” is meant a material that polymerises and/or crosslinks upon irradiation, for example, when exposed to actinic radiation, in the presence of a photoinitiator. This type of ink has the advantage that it is not necessary to evaporate the liquid phase to dry the print; instead the print is cured, a process which is more rapid than evaporation of solvent at moderate temperatures.

There are a number of sources of actinic radiation, which are commonly used to cure inkjet inks which contain radiation-curable material. The most common source of radiation is a UV source. UV sources include mercury discharge lamps, fluorescent tubes, light emitting diodes (LEDs), flash lamps and combinations thereof.

Mercury discharge lamps, fluorescent tubes and flash lamps are most commonly used as the radiation source as they generate enough power to thoroughly cure the radiation-curable ink and achieve the required balance of properties. Although these radiation sources have several drawbacks in their operational characteristics, no other UV light source has yet managed to challenge their position in terms of UV output performance.

LED UV sources are an attractive alternative. In particular, when compared to, for example mercury discharge lamps (the most common UV light source used to cure inkjet inks), LEDs offer significant cost reduction, longer maintenance intervals, higher energy efficiency and are an ecologically friendlier solution. However, when LEDs are used, it can be difficult to formulate inkjet inks having the required balance of properties, such as the required cure, blocking, adhesion and flexibility. In this regard, LEDs have a narrow wavelength output and reduced energy output when compared to other sources of UV radiation.

In order to try to achieve the required balance of properties, various inkjet components have been added to try to boost cure and film properties. For example, amine acrylates have been added to inkjet inks for curing by LEDs and an improvement in properties can often be achieved, in particular for coloured inkjet inks. However, it has been found particularly challenging to achieve the required balance of properties for a white inkjet ink, which requires an increased amount of pigment present in the ink and/or high film deposit to achieve the required colour opacity.

There is therefore a need in the art for a white inkjet ink which can achieve a desirable balance of properties, such as cure, blocking, adhesion and flexibility, even when using a UV LED source as the source of actinic radiation to cure the inkjet ink.

Accordingly, the present invention provides a white inkjet ink comprising: tricyclodecane dimethanol diacrylate; at least one of a difunctional urethane (meth)acrylate oligomer, (2-methyl-2-ethyl-1,3-dioxolane-4-yl)methyl acrylate and a polyethylene glycol diacrylate; a white pigment; and a monofunctional monomer, other than (2-methyl-2-ethyl-1,3-dioxolane-4-yl)methyl acrylate.

The inventors have surprisingly found that the inclusion of tricyclodecane dimethanol diacrylate in combination with at least one of a difunctional urethane (meth)acrylate oligomer, (2-methyl-2-ethyl-1,3-dioxolane-4-yl)methyl acrylate and a polyethylene glycol diacrylate, in the white inkjet ink of the invention provides a white inkjet ink having a desirable balance of properties, including cure, blocking, adhesion and flexibility, even when using a UV LED source as the source of actinic radiation to cure the inkjet.

The white inkjet ink of the present invention comprises tricyclodecane dimethanol diacrylate (TCDDMDA).

Tricyclodecane dimethanol diacrylate is a difunctional (meth)acrylate monomer and has CAS number 42594-17-2. It has the following structure:

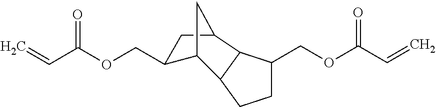 [SMILES: C=CC(=O)OCC1CC2CC1C1CCC(COC(=O)C=C)C21]

As is known in the art, monomers may possess different degrees of functionality, which include mono, di, tri and higher functionality monomers. For the avoidance of doubt, mono and difunctional are intended to have their standard meanings, i.e. one or two groups, respectively, which take part in the polymerisation reaction on curing. Multifunctional (which does not include difunctional) is intended to have its standard meaning, i.e. three or more groups, respectively, which take part in the polymerisation reaction on curing.

Tricyclodecane dimethanol diacrylate is a difunctional (meth)acrylate monomer and has two (meth)acrylate groups which take part in the polymerisation reaction on curing. For the avoidance of doubt, (meth)acrylate is intended herein to have its standard meaning, i.e. acrylate and/or methacrylate.

The present inventors have found that the inclusion of tricyclodecane dimethanol diacrylate in combination with at least one of a difunctional urethane (meth)acrylate oligomer, (2-methyl-2-ethyl-1,3-dioxolane-4-yl)methyl acrylate and a polyethylene glycol diacrylate, in the white inkjet ink as claimed provides a white inkjet ink having a desirable balance of properties, including cure, blocking, adhesion and flexibility, even when using a UV LED source as the source of actinic radiation to cure the inkjet.

In this regard, the inclusion of lower Tg, flexible components such as a difunctional urethane (meth)acrylate oligomer, (2-methyl-2-ethyl-1,3-dioxolane-4-yl)methyl acrylate and a polyethylene glycol diacrylate in an inkjet ink results in a softer film but can negatively affect the blocking. The inventors have surprisingly found that the inclusion of tricyclodecane dimethanol diacrylate in combination with at least one of a difunctional urethane (meth)acrylate oligomer, (2-methyl-2-ethyl-1,3-dioxolane-4-yl)methyl acrylate and a polyethylene glycol diacrylate in a white inkjet ink provides improved adhesion and flexibility, whilst maintaining improved blocking and cure, even when using a UV LED source as the source of actinic radiation.

In a preferred embodiment, the white inkjet ink comprises 1 to 8% by weight, preferably 2 to 5% by weight, most preferably 3 to 4% by weight, of tricyclodecane dimethanol diacrylate, based on the total weight of the ink.

The white inkjet ink of the present invention comprises at least one of a difunctional urethane (meth)acrylate oligomer, (2-methyl-2-ethyl-1,3-dioxolane-4-yl)methyl acrylate and a polyethylene glycol diacrylate.

In a preferred embodiment, the inkjet ink comprises a difunctional urethane (meth)acrylate oligomer.

A difunctional urethane (meth)acrylate oligomer is a radiation-curable (i.e. polymerisable) oligomer, and in particular is a difunctional (meth)acrylate oligomer having a urethane backbone.

The term “radiation-curable oligomer” has its standard meaning in the art, namely that the component is partially reacted to form a pre-polymer having a plurality of repeating monomer units which is capable of further polymerisation. The oligomer is a UV-curable (meth)acrylate.

The degree of functionality of the oligomer determines the degree of crosslinking and hence the properties of the cured ink. The oligomer is difunctional meaning that the average degree of functionality is two reactive functional group, namely (meth)acrylate functional groups, per molecule.

The difunctional urethane (meth)acrylate oligomer has a urethane backbone.

A preferred difunctional urethane (meth)acrylate oligomer is commercially available as Photomer 6210. Photomer 6210 has the IUPAC name of 2-hydroxyethyl prop-2-enoate;1-isocyanato-4-[(4-isocyanatocyclohexyl)methyl]cyclohexane;oxepan-2-one and has a CAS number of 52404-33-8.

The oligomer may include amine functionality when compatible with the ink components of the final inkjet ink. Therefore, in a preferred embodiment, the difunctional urethane (meth)acrylate oligomer is an amine-modified difunctional urethane (meth)acrylate oligomer.

The oligomer preferably has a molecular weight of at least 600. The molecular weight is preferably 5,000 or less. Molecular weights (number average) can be calculated if the structure of the oligomer is known or molecular weights can be measured using gel permeation chromatography using polystyrene standards.

Oligomers are typically added to inkjet inks to increase the viscosity of the inkjet ink. They therefore preferably have a viscosity of 150 mPas or above at 25° C. Preferred oligomers for inclusion in the ink of the invention have a viscosity of 0.5 to 10 Pas at 50° C. Oligomer viscosities can be measured using a rotational rheometer, which uses a 40 mm oblique/2° steel cone at 50° C. with a shear rate of 25s, such as an ARG2 rheometer manufactured by T.A. Instruments.

Preferably, the white inkjet ink comprises 1 to 6% by weight, preferably 1 to 5% by weight, most preferably 2 to 4% by weight, of a difunctional urethane (meth)acrylate oligomer, based on the total weight of the ink.

In a preferred embodiment, the white inkjet ink comprises tricyclodecane dimethanol diacrylate; a difunctional urethane acrylate (meth)oligomer; a white pigment; and a monofunctional monomer, other than (2-methyl-2-ethyl-1,3-dioxolane-4-yl)methyl acrylate. The inclusion of a difunctional urethane (meth)acrylate oligomer is particularly preferred to provide the desirable balance of properties, including cure, flexibility, adhesion and blocking.

In a preferred embodiment, the inkjet ink comprises (2-methyl-2-ethyl-1,3-dioxolane-4-yl)methyl acrylate (MEDA/Medol 10).

(2-methyl-2-ethyl-1,3-dioxolane-4-yl)methyl acrylate is a monofunctional (meth)acrylate monomer and has one (meth)acrylate group which takes part in the polymerisation reaction on curing. It has the following structure:

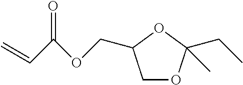

(2-methyl-2-ethyl-1,3-dioxolane-4-yl)methyl acrylate has a CAS no. of 69701-99-1, and is sometimes named alternatively as (2-methyl-2-ethyl-1,3-dioxoran-4-yl) methyl acrylate.

Preferably, the white inkjet ink comprises 5 to 20% by weight, preferably 5 to 10% by weight, of (2-methyl-2-ethyl-1,3-dioxolane-4-yl)methyl acrylate, based on the total weight of the ink.

In a preferred embodiment, the white inkjet ink comprises tricyclodecane dimethanol diacrylate; (2-methyl-2-ethyl-1,3-dioxolane-4-yl)methyl acrylate; a white pigment; and a monofunctional monomer, other than (2-methyl-2-ethyl-1,3-dioxolane-4-yl)methyl acrylate.

Preferably, the white inkjet ink comprises tricyclodecane dimethanol diacrylate; a difunctional urethane (meth)acrylate oligomer; (2-methyl-2-ethyl-1,3-dioxolane-4-yl)methyl acrylate; a white pigment; and a monofunctional monomer, other than (2-methyl-2-ethyl-1,3-dioxolane-4-yl)methyl acrylate.

In a preferred embodiment, the inkjet ink comprises a polyethylene glycol diacrylate.

A polyethylene glycol diacrylate is a difunctional (meth)acrylate monomer and has two (meth)acrylate groups which take part in the polymerisation reaction on curing.

Preferred examples of polyethylene glycol diacrylate include tetraethylene glycol diacrylate, PEG200DA, PEG300DA, PEG400DA, PEG600DA and mixtures thereof.

In a preferred embodiment, the polyethylene glycol diacrylate comprises PEG600DA.

Preferably, the white inkjet ink comprises 1 to 8% by weight, preferably 2 to 6% by weight, of a polyethylene glycol diacrylate, based on the total weight of the ink.

In a preferred embodiment, the white inkjet ink comprises tricyclodecane dimethanol diacrylate; a polyethylene glycol diacrylate; a white pigment; and a monofunctional monomer, other than (2-methyl-2-ethyl-1,3-dioxolane-4-yl)methyl acrylate.

Preferably, the white inkjet ink comprises tricyclodecane dimethanol diacrylate; a difunctional urethane (meth)acrylate oligomer; a polyethylene glycol diacrylate; a white pigment; and a monofunctional monomer, other than (2-methyl-2-ethyl-1,3-dioxolane-4-yl)methyl acrylate.

Preferably, the white inkjet ink comprises tricyclodecane dimethanol diacrylate; a difunctional urethane (meth)acrylate oligomer; (2-methyl-2-ethyl-1,3-dioxolane-4-yl)methyl acrylate; a polyethylene glycol diacrylate; a white pigment; and a monofunctional monomer, other than (2-methyl-2-ethyl-1,3-dioxolane-4-yl)methyl acrylate.

Preferably, the white inkjet ink comprises tricyclodecane dimethanol diacrylate; (2-methyl-2-ethyl-1,3-dioxolane-4-yl)methyl acrylate; a polyethylene glycol diacrylate; a white pigment; and a monofunctional monomer, other than (2-methyl-2-ethyl-1,3-dioxolane-4-yl)methyl acrylate.

The white inkjet ink of the present invention comprises a white pigment.

The white pigment is dispersed in the liquid medium of the ink. The pigment can be selected from a wide range of suitable pigments that would be known to the person skilled in the art. Preferably the white pigment is titanium dioxide, such as Kronos® 2300 available from Kronos Ltd.

Pigment particles dispersed in the ink should be sufficiently small to allow the ink to pass through an inkjet nozzle, typically having a particle size less than 8 μm, preferably less than 5 μm, more preferably less than 1 μm and particularly preferably less than 0.5 μm.

In a preferred embodiment, the inkjet ink comprises 5 to 30% by weight, preferably 10 to 20% by weight, of white pigment, based on the total weight of the ink.

The inkjet ink is a white inkjet ink and as such, is preferably free of any coloured pigments. By coloured pigments, it is meant any coloured pigment, other than white pigment.

However, minor amounts of coloured pigment, which may be present as impurities in commercially available inkjet ink components, are tolerated. For example, the ink may comprise less than 0.5% by weight, more preferably less than 0.1% by weight and most preferably less than 0.05% by weight of coloured pigments, based on the total weight of the ink. In a preferred embodiment, the inkjet ink is free of coloured pigments.

The inkjet ink of the present invention comprises a monofunctional monomer, other than (2-methyl-2-ethyl-1,3-dioxolane-4-yl)methyl acrylate.

The monofunctional monomer, other than (2-methyl-2-ethyl-1,3-dioxolane-4-yl)methyl acrylate, is not particularly limited and the formulator is free to include any such monofunctional monomer in the ink of the present invention to improve the properties or performance of the ink. The monofunctional monomer can include any monofunctional monomer readily available and known in the art in inkjet inks.

Monofunctional monomers are well known in the art. A radiation-curable monofunctional monomer has one functional group, which takes part in the polymerisation reaction on curing. The polymerisable group can be any group that is capable of polymerising upon exposure to radiation and is preferably selected from a (meth)acrylate group and a vinyl ether group.

The substituents of the monofunctional monomer are not limited other than by the constraints imposed by the use in an inkjet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

The amount of monofunctional monomer is not limited other than by the constraints imposed by the use in an inkjet ink, such as viscosity, stability, toxicity etc. In a preferred embodiment, the inkjet ink comprises 20 to 80% by weight, preferably 30 to 75% by weight, more preferably 55 to 65% by weight, of monofunctional monomer, other than (2-methyl-2-ethyl-1,3-dioxolane-4-yl)methyl acrylate, based on the total weight of the ink.

Preferably, the monofunctional monomer is selected from an N-vinyl amide monomer, N-(meth)acryloyl amine monomer, a monofunctional (meth)acrylate monomer, other than (2-methyl-2-ethyl-1,3-dioxolane-4-yl)methyl acrylate, and mixtures thereof.

In a preferred embodiment, the inkjet ink comprises an N-vinyl amide monomer and/or an N-(meth)acryloyl amine monomer.

N-Vinyl amide monomers are well-known monomers in the art. N-Vinyl amide monomers have a vinyl group attached to the nitrogen atom of an amide which may be further substituted in an analogous manner to the (meth)acrylate monomers. Preferred examples are N-vinyl caprolactam (NVC), N-vinyl pyrrolidone (NVP), N-vinyl piperidone, N-vinyl formamide and N-vinyl acetamide.

Similarly, N-(meth)acryloyl amine monomers are also well-known in the art. N-(meth)acryloyl amine monomers also have a vinyl group attached to an amide but via the carbonyl carbon atom and again may be further substituted in an analogous manner to the (meth)acrylate monomers. A preferred example is N-acryloylmorpholine (ACMO).

N-Vinyl amide monomers are particularly preferred, and most preferably NVC.

In a preferred embodiment, the monofunctional monomer comprises an N-vinyl amide monomer, preferably NVC.

In a preferred embodiment, the inkjet ink comprises 5 to 25% by weight of an N-vinyl amide monomer and/or an N-(meth)acryloyl amine monomer, based on the total weight of the ink. In a preferred embodiment, the inkjet ink comprises 5 to 25% by weight of an N-vinyl amide monomer, based on the total weight of the ink. Preferably, the inkjet ink comprises 5 to 25% by weight of NVC, based on the total weight of the ink.

The inkjet ink may also comprise one or more N-vinyl monomers other than an N-vinyl amide monomer and/or N-(meth)acryloyl amine monomer. Examples include N-vinyl carbazole, N-vinyl indole and N-vinyl imidazole.

In a preferred embodiment, the inkjet ink comprises a monofunctional (meth)acrylate monomer, other than (2-methyl-2-ethyl-1,3-dioxolane-4-yl)methyl acrylate, which are well known in the art and are preferably the esters of acrylic acid. A detailed description is therefore not required. Mixtures of (meth)acrylates may also be used.

The substituents of the monofunctional (meth)acrylate monomer are not limited other than by the constraints imposed by the use in an inkjet ink, such as viscosity, stability, toxicity etc.

In a preferred embodiment, the inkjet ink comprises a monofunctional (meth)acrylate monomer, other than (2-methyl-2-ethyl-1,3-dioxolane-4-yl)methyl acrylate, present in 20 to 70% by weight, more preferably 30 to 60% by weight, based on the total weight of the ink.

The monofunctional (meth)acrylate monomer, other than (2-methyl-2-ethyl-1,3-dioxolane-4-yl)methyl acrylate, may be a cyclic monofunctional (meth)acrylate monomer and/or an acyclic-hydrocarbon monofunctional (meth)acrylate monomer.

In a preferred embodiment, the monofunctional monomer, other than (2-methyl-2-ethyl-1,3-dioxolane-4-yl)methyl acrylate, comprises a cyclic monofunctional (meth)acrylate monomer.

The substituents of the cyclic monofunctional (meth)acrylate monomer are typically cycloalkyl, aryl and combinations thereof, any of which may be interrupted by heteroatoms and/or substituted by alkyl. Non-limiting examples of substituents commonly used in the art include C₃₋₁₈ cycloalkyl, C₆₋₁₀ aryl and combinations thereof, any of which may substituted with alkyl (such as C₁₋₁₈ alkyl) and/or any of which may be interrupted by 1-10 heteroatoms, such as oxygen or nitrogen, with nitrogen further substituted by any of the above described substituents. The substituents may together also form a cyclic structure.

The cyclic monofunctional (meth)acrylate monomer may be selected from isobornyl acrylate (IBOA), phenoxyethyl acrylate (PEA), cyclic TMP formal acrylate (CTFA), tetrahydrofurfuryl acrylate (THFA), isopropylidene glycerol acrylate (IPGA), 4-tert-butylcyclohexyl acrylate (TBCHA), 3,3,5-trimethylcyclohexyl acrylate (TMCHA), benzyl acrylate (BA) and mixtures thereof.

Preferably, the cyclic monofunctional (meth)acrylate monomer is selected from isobornyl acrylate (IBOA), cyclic TMP formal acrylate (CTFA), phenoxyethyl acrylate (PEA), and mixtures thereof.

In a preferred embodiment, the inkjet ink comprises PEA. Preferably, the inkjet ink comprises 10 to 30% by weight of PEA, based on the total weight of the ink.

Preferably, the inkjet ink comprises CTFA. Preferably, the inkjet ink comprises 5 to 25% by weight of CTFA, based on the total weight of the ink.

Preferably, the inkjet ink comprises IBOA. Preferably, the inkjet ink comprises 10 to 30% by weight IBOA, based on the total weight of the ink.

In a preferred embodiment, the monofunctional monomer comprises an N-vinyl amide monomer and a monofunctional (meth)acrylate monomer, other than (2-methyl-2-ethyl-1,3-dioxolane-4-yl)methyl acrylate.

In preferred embodiment, the monofunctional monomer comprises NVC, PEA, CTFA and IBOA. The inventors have found that the inclusion of this blend of monomers in the inkjet ink of the invention is particularly preferred as they allow for improved film properties, in particular on LED curing. The inventors have found that there is an improvement in cure, flexibility, adhesion and blocking, even when LED curing, on the inclusion of NVC, PEA, CTFA and IBOA.

The monofunctional monomer may comprise an acyclic-hydrocarbon monofunctional (meth)acrylate monomer.

The substituents of the acyclic-hydrocarbon monofunctional (meth)acrylate monomer are typically alkyl, which may be interrupted by heteroatoms. A non-limiting example of a substituent commonly used in the art is C₁₋₁₈ alkyl, which may be interrupted by 1-10 heteroatoms, such as oxygen or nitrogen, with nitrogen further substituted.

The acyclic-hydrocarbon monofunctional (meth)acrylate monomer contains a linear or branched C₆-C₂₀ group. It may be selected from octadecyl acrylate (ODA), 2-(2-ethoxyethoxy)ethyl acrylate, tridecyl acrylate (TDA), isodecyl acrylate (IDA), lauryl acrylate and mixtures thereof. In a preferred embodiment, the acyclic-hydrocarbon monofunctional (meth)acrylate monomer contains a linear C₆-C₂₀ group. For the avoidance of doubt, (meth)acrylate is intended herein to have its standard meaning, i.e. acrylate and/or methacrylate.

Monomers typically have a molecular weight of less than 600, preferably more than 200 and less than 450. Monomers are typically added to inkjet inks to reduce the viscosity of the inkjet ink. They therefore preferably have a viscosity of less than 150 mPas at 25° C., more preferably less than 100 mPas at 25° C. and most preferably less than 20 mPas at 25° C. Monomer viscosities can be measured using a rotational rheometer, which uses a 40 mm oblique/2° steel cone at 25° C. with a shear rate of 25 s⁻¹, such as an ARG2 rheometer manufactured by T.A. Instruments.

The inkjet ink may include further radiation-curable material.

The radiation-curable material is not particularly limited and the formulator is free to include any such radiation-curable material in the ink of the present invention to improve the properties or performance of the ink. This radiation-curable material can include any radiation-curable material readily available and known in the art in inkjet inks. By “radiation-curable” is meant a material that polymerises and/or crosslinks upon irradiation, for example, when exposed to actinic radiation, in the presence of a photoinitiator.

The inkjet ink may comprise an additional difunctional monomer, other than tricyclodecane dimethanol diacrylate and a polyethylene glycol diacrylate.

The functional group of the additional difunctional radiation-curable monomer, which is utilised in the ink of the present invention may be the same or different but must take part in the polymerisation reaction on curing. Examples of such functional groups include any groups that are capable of polymerising upon exposure to radiation and are preferably selected from a (meth)acrylate group and a vinyl ether group.

The substituents of the difunctional radiation-curable monomer are not limited other than by the constraints imposed by the use in an ink-jet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

When present, the inkjet ink comprises 1 to 20% by weight of additional difunctional radiation-curable monomer, preferably 5 to 10% by weight, based on the total weight of the ink.

Examples of the additional difunctional radiation-curable monomer include difunctional (meth)acrylate monomers, divinyl ether monomers, and difunctional vinyl ether (meth)acrylate monomers. Mixtures of difunctional radiation-curable monomers may be used.

In a preferred embodiment, the additional difunctional monomer comprises a difunctional (meth)acrylate monomer.

Difunctional (meth)acrylate monomers are well known in the art and a detailed description is therefore not required. Examples of additional difunctional monomers include hexanediol diacrylate (HDDA), 1,8-octanediol diacrylate, 1,9-nonanediol diacrylate, 1,10-decanediol diacrylate (DDDA), 1,11-undecanediol diacrylate and 1,12-dodecanediol diacrylate, dipropylene glycol diacrylate (DPGDA), tripropylene glycol diacrylate (TPGDA), neopentylglycol diacrylate, 3-methyl-1,5-pentanediol diacrylate (3-MPDA), and the acrylate esters of ethoxylated or propoxylated glycols and polyols, for example, propoxylated neopentylglycol diacrylate (NPGPODA), and mixtures thereof. Also included are esters of methacrylic acid (i.e. methacrylates), such as hexanediol dimethacrylate, 1,8-octanediol dimethacrylate, 1,9-nonanediol dimethacrylate, 1,10-decanediol dimethacrylate, 1,11-undecanediol dimethacrylate and 1,12-dodecanediol dimethacrylate, 1,4-butanediol dimethacrylate and mixtures thereof.

In a preferred embodiment, the additional difunctional monomer comprises a divinyl ether monomer.

Examples of a divinyl ether monomer include triethylene glycol divinyl ether (DVE-3), diethylene glycol divinyl ether, 1,4-cyclohexanedimethanol divinyl ether, bis[4-(vinyloxy)butyl] 1,6-hexanediylbiscarbamate, bis[4-(vinyloxy)butyl] isophthalate, bis[4-(vinyloxy)butyl] (methylenedi-4,1-phenylene)biscarbamate, bis[4-(vinyloxy)butyl] succinate, bis[4-(vinyloxy)butyl]terephthalate, bis[4-(vinyloxymethyl)cyclohexylmethyl] glutarate, 1,4-butanediol divinyl ether and mixtures thereof.

Triethylene glycol divinyl ether (DVE-3) is particularly preferred.

In a preferred embodiment, the additional difunctional monomer comprises a difunctional vinyl ether (meth)acrylate monomer.

Examples of a vinyl ether (meth)acrylate monomer include 2-(2-vinyloxy ethoxy)ethyl acrylate (VEEA), 2-(2-vinyloxy ethoxy)ethyl methacrylate (VEEM) and mixtures thereof.

The inkjet ink may comprise a multifunctional radiation-curable monomer. The multifunctional monomer may be selected from a tri-, tetra-, penta- or hexa-functional monomer, i.e. the radiation curable monomer has three, four, five or six functional groups.

The functional group of the multifunctional radiation-curable monomer, which is utilised in the ink of the present invention may be the same or different but must take part in the polymerisation reaction on curing. Examples of such functional groups include any groups that are capable of polymerising upon exposure to radiation and are preferably selected from a (meth)acrylate group and a vinyl ether group.

The multifunctional radiation-curable monomer may possess different degrees of functionality, and a mixture including combinations of tri and higher functionality monomers may be used.

The substituents of the multifunctional radiation-curable monomer are not limited other than by the constraints imposed by the use in an ink-jet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

When present, the inkjet ink comprises 1 to 20% by weight of a multifunctional radiation-curable monomer, preferably 5 to 10% by weight, based on the total weight of the ink.

Examples of multifunctional radiation-curable monomer include multifunctional (meth)acrylate monomers, multifunctional vinyl ether monomers and multifunctional vinyl ether (meth)acrylate monomers. Mixtures of multifunctional radiation-curable monomers may also be used.

The inkjet ink may comprise a multifunctional (meth)acrylate monomer

Suitable multifunctional (meth)acrylate monomers (which do not include difunctional (meth)acrylate monomers) include tri-, tetra-, penta-, hexa-, hepta- and octa-functional monomers. Examples of the multifunctional acrylate monomers that may be included in the inkjet inks include trimethylolpropane triacrylate, dipentaerythritol triacrylate, tri(propylene glycol) triacrylate, bis(pentaerythritol) hexaacrylate, and the acrylate esters of ethoxylated or propoxylated glycols and polyols, for example, ethoxylated trimethylolpropane triacrylate and ethoxylated pentaerythritol tetraacrylate (EOPETTA, also known as PPTTA), and mixtures thereof. Suitable multifunctional (meth)acrylate monomers also include esters of methacrylic acid (i.e. methacrylates), such as trimethylolpropane trimethacrylate. Mixtures of (meth)acrylates may also be used.

The multifunctional radiation-curable monomer may have at least one vinyl ether functional group.

The inkjet ink may comprise a multifunctional vinyl ether monomer and/or a multifunctional vinyl ether (meth)acrylate monomer.

An example of a multifunctional vinyl ether monomer is tris[4-(vinyloxy)butyl] trimellitate. When present, the multifunctional radiation-curable monomer is preferably selected from trimethylolpropane triacrylate (TMPTA), di-trimethylolpropane tetraacrylate (DiTMPTA), dipentaerythritol hexaacrylate (DPHA), ethoxylated trimethylolpropane triacrylate (EOTMPTA), ethoxylated pentaerythritol tetraacrylate (EOPETTA) and mixtures thereof.

The inkjet ink of the present invention may further comprise an additional radiation-curable (i.e. polymerisable) oligomer, other than a difunctional urethane (meth)acrylate oligomer. Any additional radiation-curable oligomer that is compatible with the other ink components is suitable for use in the ink. Preferably, the inkjet ink comprises an additional (meth)acrylate oligomer, other than a difunctional urethane (meth)acrylate oligomer

The oligomer preferably has a molecular weight of at least 600. The molecular weight is preferably 5,000 or less. Molecular weights (number average) can be calculated if the structure of the oligomer is known or molecular weights can be measured using gel permeation chromatography using polystyrene standards.

The additional oligomers may possess different degrees of functionality, and a mixture including combinations of mono, di, tri and higher functionality oligomers may be used. The degree of functionality of the additional oligomer determines the degree of crosslinking and hence the properties of the cured ink. The additional oligomer is preferably multifunctional meaning that it contains on average more than one reactive functional group per molecule. The average degree of functionality is preferably from 2 to 6.

Oligomers are typically added to inkjet inks to increase the viscosity of the inkjet ink or to provide film-forming properties such as hardness or cure speed. They therefore preferably have a viscosity of 150 mPas or above at 25° C. Preferred additional oligomers for inclusion in the ink of the invention have a viscosity of 0.5 to 10 Pas at 50° C. Oligomer viscosities can be measured using a rotational rheometer, which uses a 40 mm oblique/2° steel cone at 50° C. with a shear rate of 25 s⁻¹, such as an ARG2 rheometer manufactured by T.A. Instruments.

The additional radiation-curable oligomers comprise a backbone, for example a polyester, urethane, epoxy or polyether backbone, and one or more radiation-curable groups.

The polymerisable group can be any group that is capable of polymerising upon exposure to radiation. Preferably, the additional oligomers are (meth)acrylate oligomers, other than a difunctional urethane (meth)acrylate oligomer. The additional oligomer may include amine functionality when compatible with the ink components of the final inkjet ink. Therefore, in a preferred embodiment, the additional radiation-curable oligomer is amine-modified, preferably an amine-modified (meth)acrylate oligomer, other than an amine-modified difunctional urethane (meth)acrylate oligomer.

Particularly preferred additional radiation-curable oligomers are di-, tri-, tetra-, penta- or hexa-functional acrylates, other than a difunctional urethane (meth)acrylate oligomer.

A suitable amine-modified polyester acrylate oligomer is commercially available as UVP6600. A suitable amine-modified polyether acrylate oligomer is commercially available as CN3715LM.

Other suitable examples of additional radiation-curable oligomers include epoxy-based materials such as bisphenol A epoxy acrylates and epoxy novolac acrylates, which have fast cure speeds and provide cured films with good solvent resistance.

The amount of additional radiation-curable oligomer, when present, is preferably 0.1-10% by weight, based on the total weight of the ink.

The inkjet ink may contain one or more passive (or “inert”) resins. Passive resins are resins which are not radiation-curable and hence do not undergo crosslinking under the curing conditions to which the ink is exposed. In other words, resin is not a radiation-curable material.

Any passive resin that is compatible with the ink components of the final inkjet ink is suitable for use in the inkjet ink of the present invention. Thus, the ink formulator is able to select from a wide range of suitable passive thermoplastic resins.

The resin may be selected from epoxy, polyester, vinyl, ketone, nitrocellulose, phenoxy or acrylate resins, or a mixture thereof and is preferably a poly(methyl (meth)acrylate) resin. Methacrylate copolymers are preferred.

The resin has a weight-average molecular weight of 20-200 KDa and preferably 20-60 KDa, as determined by GPC with polystyrene standards. The resin is preferably solid at 25° C. It is preferably soluble in the liquid medium of the ink (the radiation-curable diluent and, when present, additionally the solvent). The resin may improve adhesion of the ink to the substrate.

The resin, when present, is preferably present at 0.1 to 3% by weight, based on the total weight of the ink.

If the ink is cured by exposure to a source of actinic radiation without an inert environment, one or more photoinitiators will be required. If the ink is cured by exposure to a source of low-energy electron beam radiation or a source of actinic radiation in an inert environment, the ink may still contain a photoinitiator, although photoinitiators are not required.

In a preferred embodiment, the ink of the present invention further comprises one or more photoinitiators.

Preferred are photoinitiators which produce free radicals on irradiation (free radical photoinitiators) such as, for example, diphenyl(2,4,6-trimethylbenzoyl)phosphine oxide, ethyl phenyl (2,4,6-trimethylbenzoyl) phosphinate, benzophenone, 1-hydroxycyclohexyl phenyl ketone, 2-benzyl-2-dimethylamino-(4-morpholinophenyl)butan-1-one, benzil dimethylketal, phenylbis(2,4,6-trimethylbenzoyl) phosphine oxide or mixtures thereof. Such photoinitiators are known and commercially available such as, for example, under the trade names Omnirad (from IGM) and Esacure (from Lamberti).

Diphenyl(2,4,6-trimethylbenzoyl)phosphine oxide and/or ethyl phenyl (2,4,6-trimethylbenzoyl) phosphinate are particularly preferred for inclusion in the white inkjet ink of the present invention as unlike other photoinitiators, they do not impart a yellow colour cast on the inkjet ink. As such, in a preferred embodiment, the inkjet ink comprises diphenyl(2,4,6-trimethylbenzoyl)phosphine oxide and/or ethyl phenyl (2,4,6-trimethylbenzoyl) phosphinate.

Mixtures of free radical photoinitiators can be used and preferably, the ink comprises a plurality of free radical photoinitiators. The total number of free radical photoinitiators present is preferably from one to five, and more preferably, two or more free radical photoinitiators are present in the ink.

The inkjet ink may also comprise one or more polymeric photoinitiators, such as Omnipol TP®.

Omnipol TP® is commercially available from IGM. It is a polymeric phosphine oxide photoinitiator, and is known by the chemical name polymeric ethyl (2,4,6-trimethylbenzoyl)-phenyl phosphinate or polymeric TPO-L. It has the following structure:

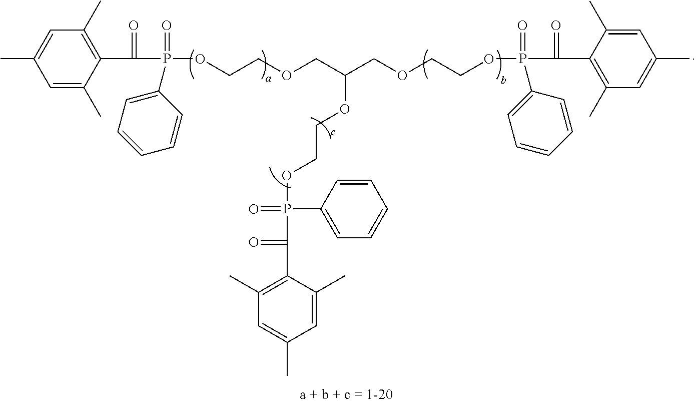

The total value of a, b and c of the chemical formula for polymeric TPO-L is equal to 1-20.

Preferably, the photoinitiator if present, is present from 1 to 20% by weight, preferably from 5 to 15% by weight, of the ink.

The presence of a photoinitiator is optional because the ink can cure without the presence of a photoinitiator by curing with a low-energy electron beam or curing by actinic radiation in an inert environment.

Therefore, the photoinitiator may be present in an amount of less than 20% by weight, preferably less than 5% by weight, more preferably less than 3%, more preferably less than 1%, based on the total weight of the ink.

Therefore, in a preferred embodiment, no photoinitiator is intentionally added to the ink. However, minor amounts of photoinitiator, which may be present as impurities in commercially available inkjet ink components, are tolerated. For example, the ink may comprise less than 0.5% by weight of photoinitiator, more preferably less than 0.1% by weight of photoinitiator, most preferably less than 0.05% by weight of photoinitiator, based on the total weight of the ink. The inkjet ink may also be free of photoinitiator.

However, an inkjet ink that is cured with a low-energy electron beam or actinic radiation in an inert environment may still contain a small amount of photoinitiator such as 1 to 5% by weight of a photoinitiator, based on the total weight of the ink. This is required if the ink is first pinned with actinic radiation.

By pinning is meant arresting the flow of the ink by treating the ink droplets quickly after they have impacted onto the substrate surface. Pinning provides a partial cure of the ink and thereby maximises image quality by controlling bleed and feathering between image areas. Pinning does not achieve full cure of the ink. By curing is meant fully curing the ink. Pinning leads to a marked increase in viscosity, whereas curing converts the inkjet ink from a liquid ink to a solid film. The dose of radiation used for pinning is generally lower than the dose required to cure the radiation-curable material fully.

The inkjet ink of the present invention preferably dries primarily by curing, i.e. by the polymerisation of the monomers present, as discussed hereinabove, and hence is a curable ink. The ink does not, therefore, require the presence of water or a volatile organic solvent to effect drying of the ink.

Accordingly, the inkjet ink preferably comprises less than 5% by weight of water and volatile organic solvents combined, based on the total weight of the ink. Preferably, the inkjet ink comprises less than 3% by weight of water and volatile organic solvent combined, more preferably less than 2% by weight combined, more preferably less than 1% by weight combined, and most preferably the inkjet ink is substantially free of water and volatile organic solvents, where the amounts are based on the total weight of the ink.

By substantially free is meant that only small amounts will be present, for example some water will typically be absorbed by the ink from the air and solvents may be present as impurities in the components of the inks, but such low levels are tolerated. In other words, no water or a volatile organic solvent is intentionally added to the ink. However, minor amounts of water or a volatile organic solvent, which may be present as impurities in commercially available inkjet ink components, are tolerated. For example, the ink may comprise less than 0.5% by weight of water or a volatile organic solvent, more preferably less than 0.1% by weight of water or a volatile organic solvent, most preferably less than 0.05% by weight of water or a volatile organic solvent, based on the total weight of the ink. In a preferred embodiment, the inkjet ink is free of water or a volatile organic solvent.

In a preferred embodiment, the ink of the present invention comprises a surfactant. The surfactant controls the surface tension of the ink. Surfactants are well-known in the art and a detailed description is not required. An example of a suitable surfactant is BYK307. In a preferred embodiment, the inkjet ink comprises an acrylated surfactant. Acrylated surfactants are particularly preferred as they can be partially included in the crosslink network on cure. Preferred examples of acrylated surfactants are commercially available as Tego Rad 2010 and Tego Rad 2300.

Adjustment of the surface tension of the inks allows control of the surface wetting of the inks on various substrates, for example, plastic substrates. Too high a surface tension can lead to ink pooling and/or a mottled appearance in high coverage areas of the print. Too low a surface tension can lead to excessive ink bleed between different coloured inks. Surface tension is also critical to ensuring stable jetting (nozzle plate wetting and sustainability). The surface tension is preferably in the range of 18-40 mNm⁻¹, more preferably 20-35 mNm⁻¹ and most preferably 20-30 mNm⁻¹.

Other components of types known in the art may be present in the ink of the present invention to improve the properties or performance. These components may be, for example, additional surfactants, defoamers, dispersants, synergists, stabilisers against deterioration by heat or light, reodorants, flow or slip aids, biocides and identifying tracers.

The inks of the invention may be prepared by known methods such as, for example, stirring with a high-speed water-cooled stirrer, or milling on a horizontal bead-mill.

The ink of the present invention has a viscosity of 1 to 40 mPas at 25° C. The ink preferably has a viscosity of 1 to 20 mPas at 25° C. Ink viscosity may be measured using a rotational viscometer fitted with a thermostatically controlled cup and spindle arrangement, running at 20 rpm at 25° C.

The present invention may also provide a cartridge containing the inkjet ink as defined herein.

The present invention also provides a method of inkjet printing comprising inkjet printing the ink as defined herein onto a substrate and curing the ink by exposing the printed ink to a curing source. In a preferred embodiment, the curing source is a UV LED source.

In the method of inkjet printing of the present invention, the ink is inkjet printed onto a substrate. Printing is performed by inkjet printing, e.g. on a single-pass inkjet printer, for example for printing (directly) onto a substrate, on a roll-to-roll printer or a flat-bed printer. As discussed above, inkjet printing is well-known in the art and a detailed description is not required.

The ink is jetted from one or more reservoirs or printing heads through narrow nozzles on to a substrate to form a printed image.

Substrates include those for packaging applications and in particular, flexible packaging applications.

Examples include substrates composed of polyvinyl chloride (PVC), polystyrene, polyester, polyethylene terephthalate (PET), polyethylene terephthalate glycol modified (PETG) and polyolefin (e.g. polyethylene, polypropylene or mixtures or copolymers thereof). Further substrates include all cellulosic materials such as paper and board, or their mixtures/blends with the aforementioned synthetic materials.

When discussing the substrate, it is the surface which is most important, since it is the surface which is wetted by the ink. Thus, at least the surface of substrate is composed of the above-discussed material.

The present invention may also provide a printed substrate having the ink as defined herein printed thereon.

In order to produce a high quality printed image a small jetted drop size is desirable. Preferably the inkjet ink is jetted at drop sizes below 90 picolitres, preferably below 35 picolitres and most preferably below 10 picolitres.

The ink of the present invention is cured by any means known in the art, such as exposure to actinic radiation and low-energy electron beam radiation.

It should be noted that the terms “dry” and “cure” are often used interchangeably in the art when referring to radiation-curable inkjet inks to mean the conversion of the inkjet ink from a liquid to solid by polymerisation and/or crosslinking of the radiation-curable material. Herein, however, by “drying” is meant the removal of the water by evaporation and by “curing” is meant the polymerisation and/or crosslinking of the radiation-curable material. Further details of the printing, drying and curing process are provided in WO 2011/021052.

In a preferred embodiment, the ink is cured by exposing the printed ink to a source of actinic radiation.

The source of actinic radiation can be any source of actinic radiation that is suitable for curing radiation-curable inks but is preferably a UV source. Suitable UV sources are well known in the art and a detailed description is not required. These include mercury discharge lamps, fluorescent tubes, light emitting diodes (LEDs), flash lamps and combinations thereof

Preferably, the source of actinic radiation is a UV LED. These are preferably provided as an array of multiple LEDs.

LEDs are increasingly used to cure inkjet inks. UV light is emitted from a UV LED source. UV LED sources comprise one or more LEDs and are well known in the art. Thus, a detailed description is not required.

There are many advantages of using LEDs as the UV source. In this regard, LEDs are cost effective, have long maintenance intervals, have high energy efficiency and are an environmentally friendly option. LEDs have a longer lifetime and exhibit no change in the power/wavelength output over time.

LEDs also have the advantage of switching on instantaneously with no thermal stabilisation time and their use results in minimal heating of the substrate. However, when LEDs are used, it can be difficult to formulate inkjet inks to obtain the required balance of properties, such as the required cure, blocking, adhesion and flexibility. In this regard, LEDs have a narrow wavelength output and reduced energy output when compared to other sources of UV radiation. It has been found to be particularly challenging to achieve the required balance of properties for a white inkjet ink when curing with a UV LED curing source, as the white inkjet ink requires an increased amount of pigment present in the ink and/or high film deposit to achieve the required colour density.

The inventors have surprisingly found that the white inkjet ink of the present invention has a desirable balance of properties, including cure, blocking, adhesion and flexibility, even when using a UV LED source as the source of actinic radiation to cure the inkjet.

It will be understood that UV LED sources emit radiation having a spread of wavelengths. The emission of UV LED light sources is identified by the wavelength which corresponds to the peak in the wavelength distribution. Compared to conventional mercury lamp UV sources, UV LED light sources emit UV radiation over a narrow range of wavelengths on the wavelength distribution. The width of the range of wavelengths on the wavelength distribution is called a wavelength band. LEDs therefore have a narrow wavelength output when compared to other sources of UV radiation. By a narrow wavelength band, it is meant that at least 90%, preferably at least 95%, of the radiation emitted from the UV LED light source has a wavelength within a wavelength band having a width of 50 nm or less, preferably, 30 nm or less, most preferably 15 nm or less.

In a preferred embodiment, at least 90%, preferably at least 95%, of the radiation emitted from the UV LED source has a wavelength in a band having a width of 50 nm or less, preferably 30 nm or less, most preferably 15 nm or less.

The ink may also be cured by exposing the printed ink to low-energy electron beam (ebeam).

The source of low-energy electron beam (ebeam) can be any source of low-energy electron beam that is suitable for curing radiation-curable inks. Suitable low-energy electron beam radiation sources include commercially available ebeam curing units, such as the EB Lab from ebeam Technologies with energy of 80-300 keV and capable of delivering a typical dose of 30-50 kGy at line speeds of up to 30 m/min. By “low-energy” for the ebeam, it is meant that it delivers an electron beam having a dose at the substrate of 100 kGy or less, preferably 70 kGy or less.

Ebeam curing is characterised by dose (energy per unit mass, measured in kilograys (kGy)) deposited in the substrate via electrons. Electron beam surface penetration depends upon the mass, density and thickness of the material being cured. Compared with UV penetration, electrons penetrate deeply through both lower and higher density materials. Unlike UV curing, photoinitiators are not required for ebeam curing to take place.

Ebeam curing is well-known in the art and therefore a detailed explanation of the curing method is not required. In order to cure the printed ink, the ink of the invention is exposed to the ebeam, which produces sufficient energy to instantaneously break chemical bonds and enable polymerisation or crosslinking.

There is no restriction on the ebeam dose that is used to cure the inkjet inks of the present invention other than that the dose is sufficient to fully cure the ink. Preferably, the dose is more than 10 kGy, more preferably more than 20 kGy, more preferably more than 30 kGy and most preferably more than kGy. Preferably, the dose is less than 100 kGy, more preferably less than 90 kGy, more preferably less than 80 kGy and most preferably less than 70 kGy. Preferably, the dose is more than 30 kGy but less than 70 kGy, more preferably more than 30 kGy but less than 60 kGy and most preferably, more than 30 kGy but 50 kGy or less. Doses above 50 kGy may cause damage to the substrate and so doses of 50 kGy or less are preferred.

The energy associated with these doses is 80-300 keV, more preferably 70-200 keV and most preferably 100 keV.

The ink cures to form a relatively thin polymerised film. The ink of the present invention typically produces a printed film having a thickness of 1 to 20 μm, preferably 1 to 10 μm, for example 2 to 5 μm.

Film thicknesses can be measured using a confocal laser scanning microscope.

The invention will now be described with reference to the following examples, which are not intended to be limiting.

### EXAMPLES

### Example 1

White inkjet inks were prepared according to the formulations set out in Table 1. The white inkjet ink formulations were prepared by mixing the components in the given amounts. Amounts are given as weight percentages based on the total weight of the ink.

TABLE 1

| Example | 1 | 2 | 3 | 4 | 5 | 6 | 7 | 8 | 9 |
|---|---|---|---|---|---|---|---|---|---|
| PEA | 4.50 | 3.80 | 4.72 | | 6.32 | 4.70 | | 1.92 | 3.24 |
| CTFA | 14.00 | 14.00 | 13.30 | 9.80 | 13.30 | 9.50 | 14.00 | 9.50 | 9.13 |
| IBOA | 19.72 | 19.92 | 19.00 | 14.42 | 19.00 | 15.22 | 19.72 | 15.20 | 14.62 |
| NVC | 15.00 | 15.00 | 14.30 | 14.70 | 14.30 | 14.30 | 15.00 | 14.30 | 13.75 |
| TCDDMDA | | 4.00 | 3.80 | 3.90 | 2.90 | 3.80 | 4.00 | 3.80 | 3.65 |
| UV-12 | 0.20 | 0.20 | 0.20 | 0.20 | 0.20 | 0.20 | 0.20 | 0.20 | 0.20 |
| Photomer 6210 | 3.50 | | 3.60 | | 2.90 | 3.60 | | 4.00 | 2.79 |
| PEG600DA | | | | | | | 4.00 | | 3.85 |
| Medol 10 | | | | 9.80 | | 7.60 | | 10.00 | 7.69 |
| Genomer 5695 | | | | | | | | | |
| Dianal BR113 | | | | 4.90 | | | | | |
| White pigment | 30.00 | 30.00 | 28.60 | 29.40 | 28.60 | 28.60 | 30.00 | 28.60 | 28.60 |
| dispersion | | | | | | | | | |
| TPO | 12.00 | 12.00 | 11.40 | 11.80 | 11.40 | 11.40 | 12.00 | 11.40 | 11.40 |
| 2,5-bis(tert- | 0.08 | 0.08 | 0.08 | 0.08 | 0.08 | 0.08 | 0.08 | 0.08 | 0.08 |
| butyl-2- | | | | | | | | | |
| benzoxazol-2- | | | | | | | | | |
| yl) thiophene | | | | | | | | | |
| Tego Rad 2010 | 1.00 | 1.00 | 1.00 | 1.00 | 1.00 | 1.00 | 1.00 | 1.00 | 1.00 |
| Total | 100 | 100 | 100 | 100 | 100 | 100 | 100 | 100 | 100 |

PEA, CTFA, IBOA, Medol 10 and NVC are monofunctional monomers described hereinabove. TCDDMDA and PEG500DA are difunctional monomers described hereinabove. Dianal BR113 is an acrylic resin solution in PEA (79% PEA, 20% Dianal BR1 13, 1% UV12, based on the total weight of the acrylic resin solution). UV12 is a stabiliser. Photomer 6210 is a urethane diacrylate oligomer. Genomer 5695 is a modified acrylated polyetherpolyol. 2,5-bis(tert-butyl-2-benzoxazol-2-yl) thiophene is a brightener. Tego Rad 2010 is an acrylated polyether siloxane. TPO is a photoinitiator.

The white pigment dispersion contains 50% pigment, 3.5% polymeric dispersing aid, 1% UV12 and 45.5% PEA. Amounts are given as weight percentages based on the total weight of the dispersion.

Examples 1 and 2 are comparative examples. Comparative Example 1 is a comparative example as it does not have TCDDMDA present therein. Comparative Example 2 is a comparative example as it has no photomer 6210, PEG600DA or Medol 10 present. Inks 3-9 are inks of the invention having TCDDMDA present and at least one of photomer 6210, PEG600DA or Medol 10 present therein.

The inks of Table 1 were then assessed for adhesion, blocking, flexibility and cure. The tests and results are set out below.

### Adhesion

In order to assess adhesion, the inkjet inks of Table 1 were printed using an Acuity LED48 in quality mode at 100% and 50% density onto a clear vinyl substrate and a polycarbonate substrate and cured to provide a cured ink film. The ink films were then left to stand for at least 24 hours.

The adhesion was assessed by subjecting each of the above prints to a cross hatch test according to ASTM D-3359 using 3M Scotch 600 tape. The degree of film removed with the tape was then quantified as a percentage and scored according to the following scale as defined in ASTM D-3359:

| Scale | Ink Loss |
|---|---|
| 0 | Greater than 65% loss |
| 1 | Between 35 and 65% loss |
| 2 | Between 15 and 35% loss |
| 3 | Between 5 and 15% loss |
| 4 | Less than 5% loss |
| 5 | No loss |

A mean average of the results was taken for each ink and the results are provided in Table 2.

TABLE 2

| Example | 1 | 2 | 3 | 4 | 5 | 6 | 7 | 8 | 9 |
|---|---|---|---|---|---|---|---|---|---|
| Clear Vinyl | 4.3 | 3.7 | 5 | 4.7 | 4.7 | 4.7 | 4 | 5 | 5 |
| PC | 3 | 4 | 4 | 4.7 | 4.7 | 4.7 | 4.7 | 5 | 5 |

As can be seen, Examples 3-9 have improved adhesion results compared to comparative Examples 1 and 2.

It is clear from these results that TCDDMDA and at least one of a difunctional urethane (meth)acrylate oligomer, (2-methyl-2-ethyl-1,3-dioxolane-4-yl)methyl acrylate and a polyethylene glycol diacrylate is required for adhesion.

### Blockinq

In order to assess blocking, the inkjet inks of Table 1 were printed using an Acuity LED48 in quality mode in 1, 2 and 3 layers onto a clear vinyl substrate and cured to provide a cured ink film.

Further prints were produced with Uvijet GP coloured inks in production mode using an Acuity LED48 printer.

Prints were stacked so that each of the 1, 2 and 3 white layers face the reverse of the media and separately additionally face a coloured ink print. Weight was applied to the top plate equating to 700 kg/m² and left for 24 hours. Each layerwas then carefully separated and judged for degree of noise and ink offset according to the scale below.

| Scale | Noise | Offset |
|---|---|---|
| 1 | Stuck together | Stuck together |
| 2 | Severe noise | Severe offset |
| 3 | Noise | Some offset |
| 4 | Slight noise | Slight offset |
| 5 | No noise | No offset |

A mean average of the results for all six combinations for each ink was taken and the results are provided in Table 3.

TABLE 3

| Example | 1 | 2 | 3 | 4 | 5 | 6 | 7 | 8 | 9 |
|---|---|---|---|---|---|---|---|---|---|
| Noise | 3 | 4.2 | 4.7 | 4.5 | 4.5 | 4 | 4.2 | 4.8 | 4 |
| Offset | 3.6 | 4.7 | 4.8 | 4.8 | 4.8 | 4.8 | 4.8 | 4.7 | 4.7 |

As can be seen, Examples 3-9 have improved blocking results compared to comparative Example 1.

It is clear that TCDDMDA is required for improved blocking.

### Flexibility

In order to assess flexibility, the inkjet inks of Table 1 were printed using an Acuity LED48 in quality layered mode with two layers of white and one layer of Uvijet GP coloured ink onto a clear vinyl substrate, where the white ink is the first layer on the media, and cured to provide a cured ink film. The ink films were then left to stand for at least 24 hours.

Flexibility was assessed making a cut through the media with a Stanley knife across the print. A visual assessment was made of the degree of ink damage at the edges of the cut on a scale from 1 to 5. 5 was awarded for no visible damage and 1 was awarded for significant flaking of the ink from the cut.

The results are provided in Table 4.

TABLE 4

| Example | 1 | 2 | 3 | 4 | 5 | 6 | 7 | 8 | 9 |
|---|---|---|---|---|---|---|---|---|---|
| Clear Vinyl | 4 | 3.5 | 4 | 4 | 4 | 4 | 4 | 4.5 | 4.8 |

As can be seen, Examples 3-9 have improved flexibility compared to comparative Example 2. It is clear from these results that at least one of a difunctional urethane (meth)acrylate oligomer, (2-methyl-2-ethyl-1,3-dioxolane-4-yl)methyl acrylate and a polyethylene glycol diacrylate is required for flexibility.

### Cure

In order to assess for cure, the inkjet inks of Table 1 were printed using an Acuity LED48 in quality mode at 10% density steps from 10 to 100% onto a black styrene substrate and cured to provide a cured ink film. The ink films were then left to stand for at least 24 hours.

Cure was assessed by firmly rubbing each density step image by hand 10 times using a lint free cloth. Damage to the ink film was assessed on a scale from 1 to 5, where 1 is complete removal and 5 is no damage.

A mean average of the results was taken for each ink and the results are provided in Table 5.

TABLE 5

| Example | 1 | 2 | 3 | 4 | 5 | 6 | 7 | 8 | 9 |
|---|---|---|---|---|---|---|---|---|---|
| Styrene | 4.6 | 4.1 | 4.5 | 4.4 | 5 | 4.4 | 4.7 | 4.8 | 4.6 |

As can be seen, Examples 3-9 have improved cure results compared to comparative Example 2. It is clear from these results that at least one of a difunctional urethane (meth)acrylate oligomer, (2-methyl-2-ethyl-1,3-dioxolane-4-yl)methyl acrylate and a polyethylene glycol diacrylate is required for cure. Comparative Example 2 has no difunctional urethane (meth)acrylate oligomer, (2-methyl-2-ethyl-1,3-dioxolane-4-yl)methyl acrylate or polyethylene glycol diacrylate present, and as a result is easily smudged with poor cure results.

1. A white inkjet ink comprising: tricyclodecane dimethanol diacrylate; at least one of a difunctional urethane (meth)acrylate oligomer, (2-methyl-2-ethyl-1,3-dioxolane-4-yl)methyl acrylate and a polyethylene glycol diacrylate; a white pigment; and a monofunctional monomer, other than (2-methyl-2-ethyl-1,3-dioxolane-4-yl)methyl acrylate.

2. The white inkjet ink as claimed in claim 1, wherein the inkjet ink comprises 1 to 8% by weight of tricyclodecane dimethanol diacrylate, based on the total weight of the ink.

3. The white inkjet ink as claimed in claim 1, wherein the inkjet ink comprises a difunctional urethane (meth)acrylate oligomer, preferably present in 1 to 6% by weight, based on the total weight of the ink.

4. The white inkjet ink as claimed in claim 1, wherein the inkjet ink comprises (2-methyl-2-ethyl-1,3-dioxolane-4-yl)methyl acrylate, preferably present in 5 to 20% by weight, based on the total weight of the ink.

5. The white inkjet ink as claimed in claim 2, wherein the inkjet ink comprises a polyethylene glycol diacrylate, preferably present in 1 to 8% by weight, based on the total weight of the ink.

6. The white inkjet ink as claimed in claim 1 comprising 5 to 30% by weight of white pigment, based on the total weight of the ink.

7. The white inkjet ink as claimed in claim 1 comprising 20 to 80% by weight of monofunctional monomer, other than (2-methyl-2-ethyl-1,3-dioxolane-4-yl)methyl acrylate, based on the total weight of the ink.

8. The white inkjet ink as claimed in claim 1, wherein the monofunctional monomer is selected from an N-vinyl amide monomer, N-(meth)acryloyl amine monomer, a monofunctional (meth)acrylate monomer, other than (2-methyl-2-ethyl-1,3-dioxolane-4-yl)methyl acrylate, and mixtures thereof.

9. The white inkjet ink as claimed in claim 1, wherein the monofunctional monomer comprises a cyclic monofunctional (meth)acrylate monomer, other than (2-methyl-2-ethyl-1,3-dioxolane-4-yl)methyl acrylate.

10. The white inkjet ink as claimed in claim 9, wherein the cyclic monofunctional (meth)acrylate monomer is selected from phenoxyethyl acrylate, cyclic TMP formal acrylate, isobornyl acrylate and mixtures thereof.

11. The white inkjet ink as claimed in claim 1, wherein the monofunctional monomer comprises an N-vinyl amide monomer, preferably N-vinyl caprolactam.

12. The white inkjet ink as claimed in claim 1, wherein the monofunctional monomer comprises phenoxyethyl acrylate, cyclic TMP formal acrylate, isobornyl acrylate and N-vinyl caprolactam.

13. A method of inkjet printing comprising inkjet printing the inkjet ink as claimed in claim 1 onto a substrate and curing the inkjet ink by exposing the inkjet ink to a curing source.

14. The method of inkjet printing as claimed in claim 13, wherein the curing source is a UV LED source.

15. The substrate having the inkjet ink as claimed in claim 1 printed thereon.
